(19) United States
(12) Patent Application Publication
(10) Pub. No.: US 2025/0211037 A1
(43) Pub. Date: Jun. 26, 2025

(54) MOTOR AND ROTARY BLADE DEVICE

(71) Applicant: MINEBEA MITSUMI Inc., Nagano (JP)

(72) Inventor: Shintaro NAKAMURA, Kitasaku-gun, Nagano (JP)

(21) Appl. No.: 18/848,174

(22) PCT Filed: Feb. 14, 2023
(86) PCT No.: PCT/JP2023/004966

§ 371 Date: Sep. 18, 2024

(30) Foreign Application Priority Data
Mar. 31, 2022 (JP) 2022-059154

(51) Int. Cl. H02K 1/16; B64U 30/29; H02K 1/2791

(52) U.S. Cl. CPC H02K 1/16; B64U 30/29; H02K 1/2791

(57) ABSTRACT

A motor and a rotary blade device capable of increasing dustproof and waterproof performance is provided. A motor includes an annular rotor and a stator opposing the rotor. The rotor includes a magnet and a housing covering the magnet. The stator includes a coil and a holder holding the coil. The housing includes a first projecting part projecting toward the holder. The holder includes a second projecting part projecting toward the housing. The second projecting part opposes the first projecting part via a gap in a radial direction.

### TECHNICAL FIELD

The present invention relates to a motor and a rotary blade device including the motor.

### BACKGROUND ART

Conventionally, as disclosed in Patent Document 1, there is known a motor including a rotor hole part partitioned by a rotor rib part constituting a part of a rotor. The rotor hole part forms an air path with respect to a stator such as a stator core and a coil accommodated in the rotor. When the motor is driven, the stator is cooled by flow of air in the air path.

### CITATION LIST

### Patent Literature

Patent Document 1: JP 2019-68604 A

### SUMMARY OF INVENTION

### Technical Problem

The air path exposes the stator to the outside. When the motor is used for a rotary blade device incorporated in, for example, an unmanned aerial vehicle (UAV) or the like, not only air but also water and dust may enter the motor through the air path. Thus, it is required to increase dustproof and waterproof performance of the motor.

The present invention has been made in light of the above problem, and an object is to provide a motor and a rotary blade device capable of increasing dustproof and waterproof performance.

### Solution to Problem

To achieve the above object, a motor according to the present invention includes
an annular rotor, and
a stator opposing the rotor, wherein
the rotor includes a magnet and a housing covering the magnet,
the stator includes a coil and a holder holding the coil,
the housing includes a first projecting part projecting toward the holder,
the holder includes a second projecting part projecting toward the housing, and
the second projecting part includes the second projecting part opposing the first projecting part via a gap in a radial direction.

### BRIEF DESCRIPTION OF DRAWINGS

FIG. 1 is a perspective view schematically illustrating an external appearance of a motor 1 according to an embodiment of the present invention.

FIG. 2 is a perspective cross-sectional view taken along line 2-2 in FIG. 1.

FIG. 3 is a perspective view of a holder 11 alone, the perspective view schematically illustrating a configuration of the holder 11.

FIG. 4 is a perspective cross-sectional view taken along line 4-4 in FIG. 1.

FIG. 5 is a plan view schematically illustrating a configuration of the motor 1 according to the embodiment of the present invention.

FIG. 6 is a perspective view of the motor 1 according to the embodiment of the present invention, the perspective view schematically illustrating a state of the motor 1 with a housing 21 being removed from the motor 1.

FIG. 7 is a partial cross-sectional view taken along line 7-7 in FIG. 1.

FIG. 8 is a perspective view of the housing 21 alone, the perspective view schematically illustrating a configuration of the housing 21.

FIG. 9 is a cross-sectional view schematically illustrating a structure of a rotary blade device 2 according to the embodiment of the present invention.

### DESCRIPTION OF EMBODIMENTS

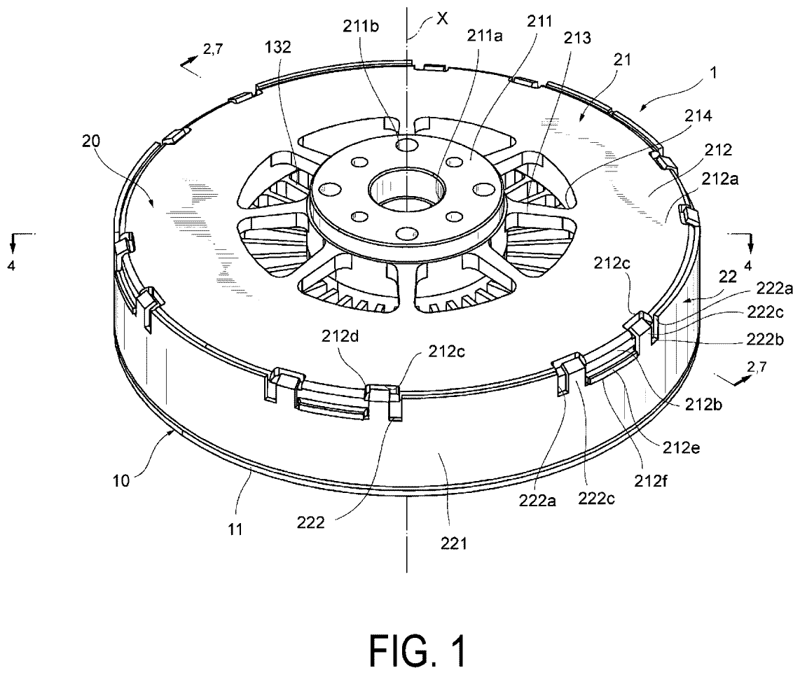

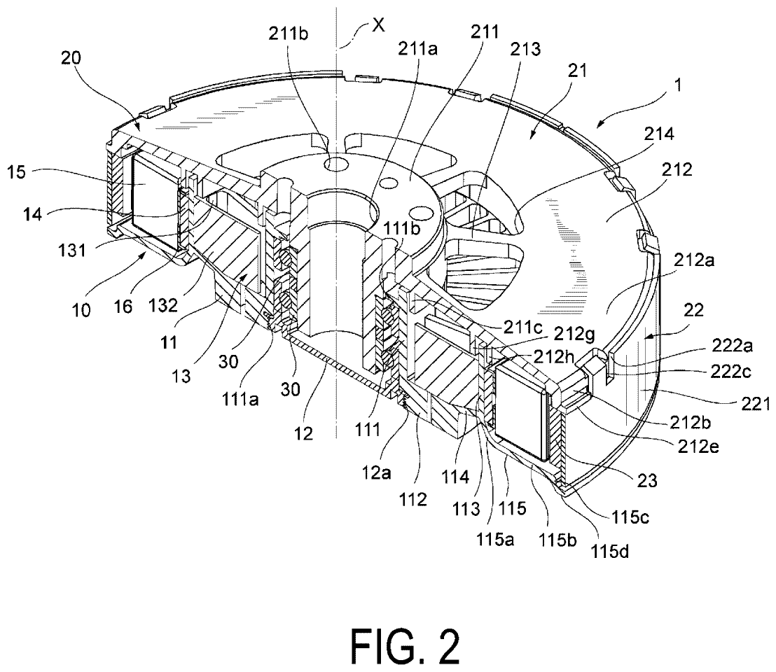

An embodiment of the present invention will be described below with reference to the drawings. FIG. 1 is a perspective view schematically illustrating an external appearance of a motor 1 according to the embodiment of the present invention. FIG. 2 is a perspective cross-sectional view taken along line 2-2 in FIG. 1. The motor 1 is, for example, a brushless motor of an outer-rotor type mounted at, for example, an unmanned aerial vehicle (UAV) and, as illustrated in FIGS. 1 and 2, has, for example, a substantially flat cylindrical contour. The motor 1 includes a stator 10 and an annular rotor 20 supported by the stator 10 rotatably about an axial line X and opposing the stator 10.

Note that in the following description of the present embodiment, an extending direction of the axial line X is referred to as an axial line X direction. Further, in the axial line X direction, one direction side is defined as an upper side, and another direction side is defined as a lower side. For example, in FIGS. 1 and 2, a side of disposing the stator 10 is defined as the lower side, and a side of disposing the rotor 20 is defined as the upper side. Further, a direction orthogonal to the axial line X is defined as a radial direction. In the radial direction, a side toward the axial line X is defined as an inner peripheral side or an inner side in the radial direction, and a side away from the axial line X is defined as an outer peripheral side or an outer side in the radial direction. Moreover, a direction around the axial line X is defined as a circumferential direction.

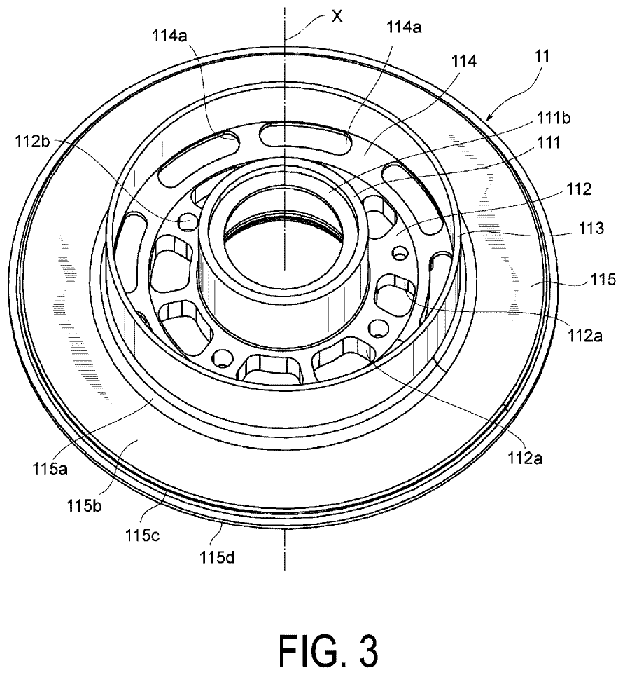

First, the stator 10 will be described. The stator 10 includes a holder 11 constituting a base of the motor 1. FIG. 3 is a perspective view of the holder 11 alone, the perspective view schematically illustrating a configuration of the holder 11. Referring also to FIGS. 2 and 3, the holder 11 includes an inner wall part 111 defined at the inner peripheral side, an attachment part 112 continuous with a lower side of the inner wall part 111, an outer wall part (second projecting part) 113 defined at the outer peripheral side, a connection part 114 connecting the attachment part 112 and the outer wall part 113, and an annular part 115 expanding from the outer wall part 113 toward the outer peripheral side. The inner wall part 111, the attachment part 112, the outer wall part 113, the connection part 114, and the annular part 115 are integrally formed of a non-magnetic material including a metal material such as aluminum or a resin material.

The inner wall part 111 is formed in a cylindrical shape with the axial line X as a central axis. An upper end and a lower end of the inner wall part 111 are open. As illustrated in FIG. 2, outer rings of two bearings 30 and 30 arranged in the axial line X direction are held at an inner peripheral surface of the inner wall part 111. The bearings 30 are fitted into the inner wall part 111 and fixed to the inner peripheral surface of the inner wall part 111 with an adhesive. However, the bearings 30 may be fixed to the inner peripheral surface of the inner wall part 111 by a given method such as press fitting, transition fitting, or clearance fitting. The inner wall part 111 functions as a bearing holder (bearing holding part) of the two bearings 30 and 30. The bearings 30 are ball bearings, for example. However, other bearings such as a sleeve bearing may be used as the bearings 30.

A pusher 12 formed in a thin plate-like disk shape is fixed to an opening at the lower end of the inner wall part 111. The pusher 12 has a function to apply a preload to the bearings 30. For example, a male screw 12a is formed at an outer peripheral surface of the pusher 12. On the other hand, a female screw 111a is formed at an inner peripheral surface of the opening at the lower end of the inner wall part 111. Thus, the pusher 12 is fixed to the opening at the lower end of the inner wall part 111 by being screwed into the opening at the lower end of the inner wall part 111. The pusher 12 is formed of, for example, a metal material such as aluminum or a resin material. Note that although the bearings 30 apply a preload by constant-position preloading using the pusher 12, no such limitation is intended. For example, an elastic member such as a spring or a plate spring may be disposed between the bearings 30 and the pusher 12, and a preload may be applied to the bearings 30 by constant-pressure preloading.

As described in FIG. 3, the attachment part 112 is a part for attaching the motor 1 to an aircraft body part of a UAV (external device) (not illustrated). The attachment part 112 is formed in a flat annular shape extending from the lower end of the inner wall part 111 toward the outer peripheral side. A plurality of (for example, eight) opening parts (second opening parts) 112a arranged in the circumferential direction are formed in the attachment part 112. Each opening part 112a passes through the attachment part 112 in the axial line X direction. The opening parts 112a allow wiring extending to the aircraft body part and flow of air from the inside of the motor 1 to the exterior space. A plurality of screw holes 112b for attaching the motor 1 to the aircraft body part are further formed in the attachment part 112.

The outer wall part 113 is formed in a cylindrical shape with the axial line X as a central axis. An inner peripheral surface of the outer wall part 113 opposes, for example, an outer peripheral surface of the inner wall part 111. An upper end of the attachment part 112 and a lower end of the outer wall part 113 are connected to each other by the connection part 114. The connection part 114 is inclined so as to extend upward from the attachment part 112 toward the outer wall part 113. A plurality of (for example, eight) opening parts (second opening parts) 114a arranged in the circumferential direction are formed in the connection part 114. The opening parts 114a pass through the connection part 114 in the axial line X direction. The opening parts 114a allow flow of air from the inside of the motor 1 to the exterior space.

The annular part 115 expands annularly from the lower end of the outer wall part 113 toward the outer peripheral side. The annular part 115 includes an inclined part 115a connected to the lower end of the outer wall part 113 and inclined downward toward the outer peripheral side, a flat part 115b expanding from an outer peripheral end of the inclined part 115a along, for example, a virtual plane orthogonal to the axial line X, a projecting part (third projecting part) (hereinafter referred to as an “axial direction projecting part”) 115c projecting downward in the axial line X direction from an outer peripheral end of the flat part 115b, and a projecting part (fourth projecting part) (hereinafter referred to as a “radial direction projecting part”) 115d projecting toward the outer peripheral side in the radial direction from a lower end of the axial direction projecting part 115c.

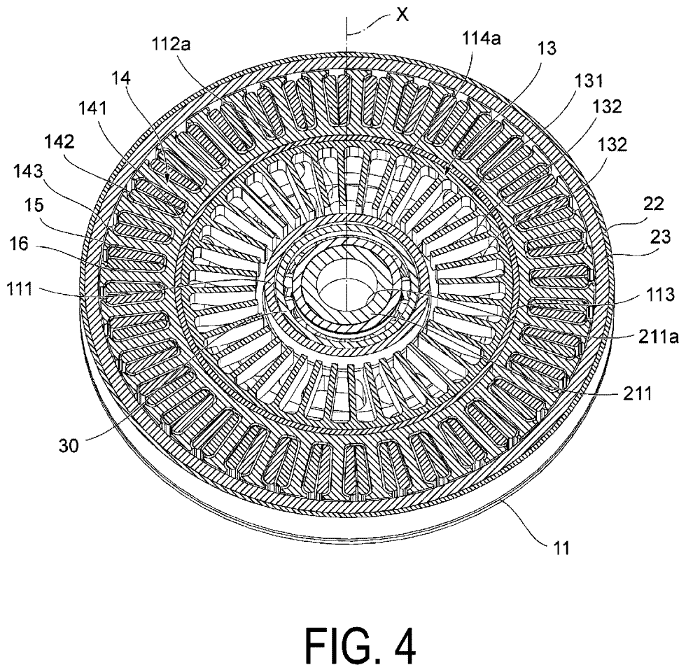

As illustrated in FIG. 2, the stator 10 includes a heat sink (heat radiating part) 13 disposed between the outer peripheral surface of the inner wall part 111 and the inner peripheral surface of the outer wall part 113. FIG. 4 is a perspective cross-sectional view taken along line 4-4 in FIG. 1. Referring also to FIGS. 2 and 4, the heat sink 13 includes a cylindrical main body 131 fixed, at an outer peripheral surface, to the inner peripheral surface of the outer wall part 113 of the holder 11, and a plurality of (for example, 36) fins 132 extending from an inner peripheral surface of the main body 131 to the inner peripheral side toward the axial line X. The main body 131 and the fins 132 are integrally formed of, for example, a metal material having high thermal conductivity such as aluminum alloy. The main body 131 is fixed to the inner peripheral surface of the outer wall part 113 using, for example, an adhesive having high thermal conductivity.

The plurality of fins 132 are arranged, for example, at equal intervals in the circumferential direction. In the present embodiment, an end part of each fin 132 at the inner peripheral side opposes the outer peripheral surface of the inner wall part 111 of the holder 11 via a gap. As illustrated in FIG. 2, the heat sink 13 is in contact with the inner peripheral surface of the outer wall part 113 and upper surfaces of the attachment part 112 and the connection part 114 at the outer peripheral surface and a lower surface of the main body 131 and lower surfaces of the fins 132. Thus, heat is transferred from coils and a magnet described below via the holder 11. The main body 131 and the plurality of fins 132 are arranged at positions corresponding to the opening parts 112a and the opening parts 114a of the holder 11 in the axial line X direction.

The stator 10 includes a stator core 14 fixed to an outer peripheral surface of the outer wall part 113 of the holder 11, a plurality of coils 15 wound around the stator core 14, and a plurality of insulators 16 disposed between the stator core 14 and the respective coils 15. The stator core 14 is formed of a stacked body of silicon steel plates or the like being magnetic materials, and functions as a yoke of the stator 10.

As illustrated in FIG. 4, the stator core 14 includes a cylindrical base end part 141, a plurality of (for example, 36) teeth 142 extending from the base end part 141 toward the outer peripheral side, and a distal end part 143 defined at an outer peripheral end of each of the teeth 142. An inner peripheral surface of the base end part 141 is held at the outer peripheral surface of the outer wall part 113 of the holder 11 using, for example, an adhesive. The teeth 142 are arranged at equal intervals in the circumferential direction. The size of each distal end part 143 defined in the circumferential direction is set to be larger than the size of each tooth 132 similarly defined in the circumferential direction.

The coils 15 are held by the stator core 14, that is, the holder 11, by being wound around the respective teeth 142. The insulators 16 formed of an insulation material are disposed between the stator core 14 and the coils 15. Thus, electrical insulation is obtained between the stator core 14 and the coils 15. Note that, instead of disposing the insulators 16, electrical insulation may be obtained by applying or forming a resin film having insulating properties at a surface of the stator core 14.

Next, the rotor 20 will be described. Referring also to FIGS. 1 and 2, the rotor 20 includes a substantially disc-shaped housing 21 rotatably supported by the inner wall part 111 of the holder 11 of the stator 10 via the bearings 30 and 30, a cylindrical yoke 22 attached to an outer peripheral end of the housing 21, and a cylindrical magnet (permanent magnet) 23 attached to an inner peripheral surface of the yoke 22. An inner peripheral surface of the magnet 23 opposes outer peripheral surfaces of the distal end parts 143 of the stator core 14 of the stator 10 via a gap. Note that, although the magnet 23 has a cylindrical shape, a single magnet may be formed in a cylindrical shape, or a plurality of magnets may be connected to form a cylindrical shape.

The housing 21 includes a cylindrical inner peripheral part 211 defined at the inner peripheral side, an annular outer peripheral part 212 defined at the outer peripheral side, a plurality of (for example, eight) connection members, that is, spokes 213 connecting the inner peripheral part 211 and the outer peripheral part 212 to each other, and a plurality of (for example, eight) opening parts (first opening parts) 214 defined between the mutually adjacent spokes 213 and 213. The inner peripheral part 211, the outer peripheral part 212, and the spokes 213 are integrally formed of a metal material such as aluminum or a resin material.

The inner peripheral part 211 is formed in a cylindrical shape with the axial line X as a central axis. The inner peripheral part 211 includes a through hole 211a passing through the inner peripheral part 211 from an upper end of the inner peripheral part 211 to a lower end of the inner peripheral part 211. Inner rings of the bearings 30 and 30 are held at an outer peripheral surface of the inner peripheral part 211. An adhesive is used for holding. However, instead of the adhesive, the bearings 30 and 30 may be fixed to the inner peripheral part 211 by, for example, a given method such as press fitting, transition fitting, or clearance fitting to the outer peripheral surface of the inner peripheral part 211. Note that the through hole 211a does not need to be formed. In other words, the inner peripheral part 211 may have a solid columnar shape. A plurality of screw holes 211b for attaching a propeller of a UAV or the like are formed in an upper surface of the inner peripheral part 211.

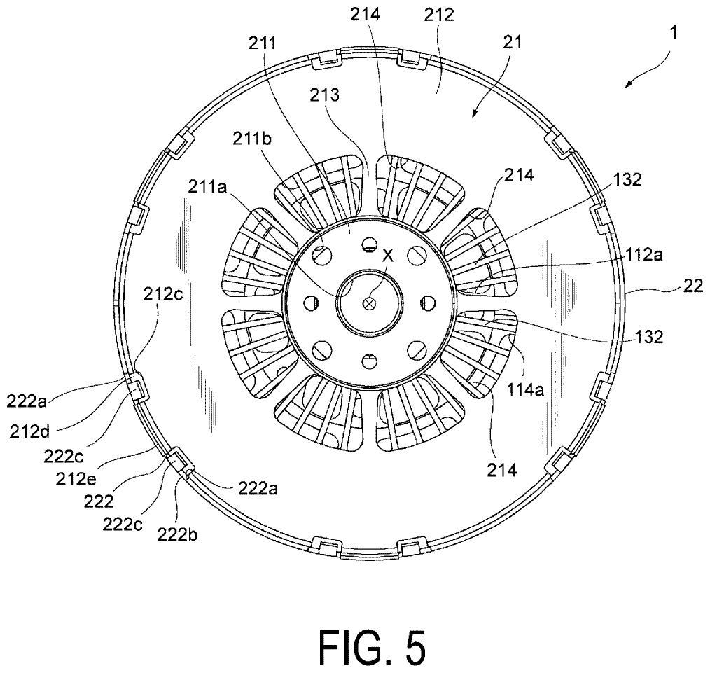

Each spoke 213 extends in the radial direction between the inner peripheral part 211 and the outer peripheral part 212. FIG. 5 is a plan view schematically illustrating a configuration of the motor 1 according to the embodiment of the present invention. As is clear from FIG. 5, the opening parts 214 are arranged at positions corresponding to the opening parts 112a and the opening parts 114a of the holder 11 of the stator 10 in the axial line X direction. Thus, flow paths of air are formed between the opening parts 214, the opening parts 112a, and the opening parts 114a in the axial line X direction. The fins 132 of the heat sink 13 are disposed in these flow paths. Note that the opening parts 214 may be arranged at positions corresponding to the opening parts 112a and flow paths of air may be formed between the opening parts 214 and the opening parts 112a.

As illustrated in FIG. 2, the outer peripheral part 212 includes a covering part 212a annularly expanding in the radial direction so as to cover an upper surface of the outer wall part 113 of the holder 11 of the stator 10, and a projecting part 212b annularly projecting downward in the axial line X direction from an outer peripheral end of the covering part 212a. A lower end of the projecting part 212b is in contact with and is received by an upper end of the magnet 23. At least a part of an outer peripheral surface of the projecting part 212b opposes the inner peripheral surface of the yoke 22.

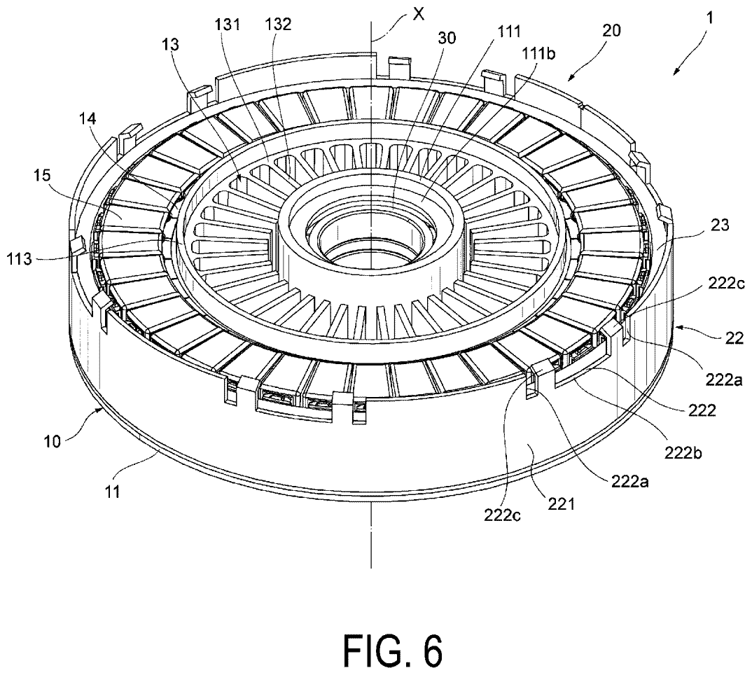

FIG. 6 is a perspective view of the motor 1 according to the embodiment of the present invention, the perspective view schematically illustrating a state of the motor 1 with the housing 21 being removed from the motor 1. Referring also to FIGS. 1, 2 and 6, the yoke 22 is formed in a cylindrical shape with the axial line X as a central axis. The magnet 23 formed in a cylindrical shape with the axial line X as a central axis is attached to the inner peripheral surface of the yoke 22. For example, an adhesive is used for fixing of the magnet 23. The yoke 22 is formed of a magnetic material such as iron.

The yoke 22 includes a cylindrical main body 221. In the main body 221, a plurality of (for example, six) cutouts 222 are formed at given intervals in the circumferential direction at an upper end of the main body 221. In the present embodiment, each cutout 222 is formed by, for example, a pair of side surfaces 222a and 222a defined along virtual planes including the axial line X and a bottom surface 222b defined along a virtual plane orthogonal to the axial line X. Thus, the cutout 222 is formed in, for example, a rectangular shape. The bottom surface 222b extends along substantially the same plane as an upper surface of the magnet 23, for example.

The yoke 22 includes, for example, two engaging parts 222c projecting upward in the axial line X direction from the bottom surface 222b in each cutout 222. On the other hand, a plurality of (for example, twelve) recessed parts 212c are formed at an outer peripheral end of an upper surface of the covering part 212a of the outer peripheral part 212 of the housing 21 in a manner corresponding to the engaging parts 222c. Bottom surfaces 212d of the recessed parts 212c extend along a virtual plane orthogonal to the axial line X. Upper ends of the engaging parts 222c of the yoke 22 are bent toward the axial line X, and the engaging parts 222c are engaged to the recessed parts 212c of the housing 21. Thus, the yoke 22 is attached to the housing 21.

Referring also to FIGS. 1 and 2, each of the cutouts 222 of the yoke 22 receives a protruding part 212e protruding toward the outer peripheral side from the outer peripheral surface of the projecting part 212b of the outer peripheral part 212 of the housing 21 of the rotor 20. The protruding part 212e extends for a predetermined length in the circumferential direction. The outer diameter of an outer peripheral end of the protruding part 212e defined in the radial direction with respect to the axial line X may be set to be larger than the outer diameter of an outer peripheral surface of the main body 221 of the yoke 22 defined similarly. In addition, a bottom surface 212f of the protruding part 212e is in contact with and is received by the bottom surface 222b of the cutout 222 of the yoke 22.

The magnet 23 is, for example, a permanent magnet integrally formed of a magnetic material. The magnet 23 includes S-pole regions magnetized to the S-pole and N-pole regions magnetized to the N-pole. The S-pole regions and the N-pole regions are alternately arranged in the circumferential direction. As described above, since the upper surface of the magnet 23 extends along substantially the same plane as the bottom surfaces 222b of the cutouts 222 of the yoke 22, the upper surface of the magnet 23 is defined to be lower than an upper surface of the main body 221 of the yoke 22 in the axial line X direction.

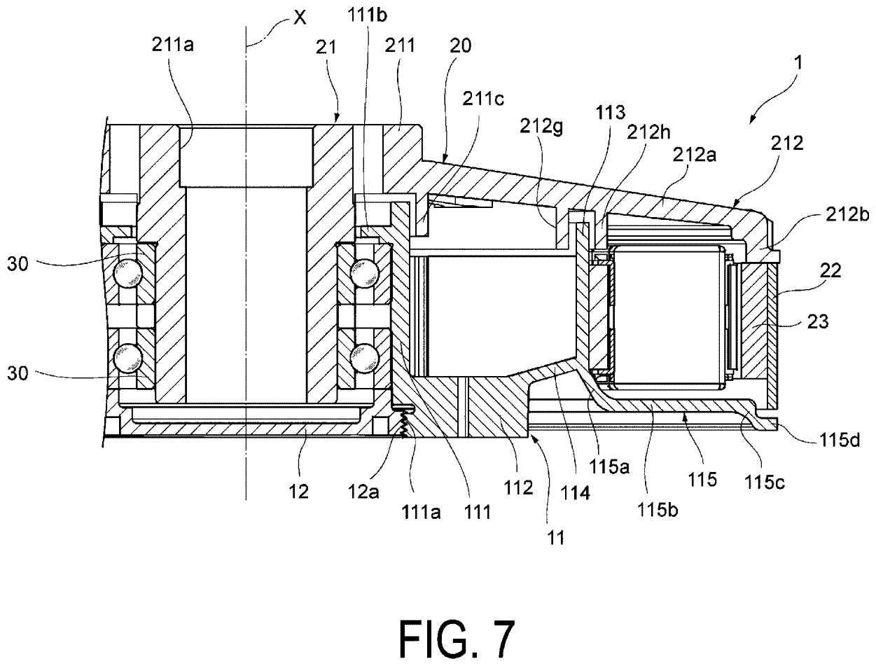

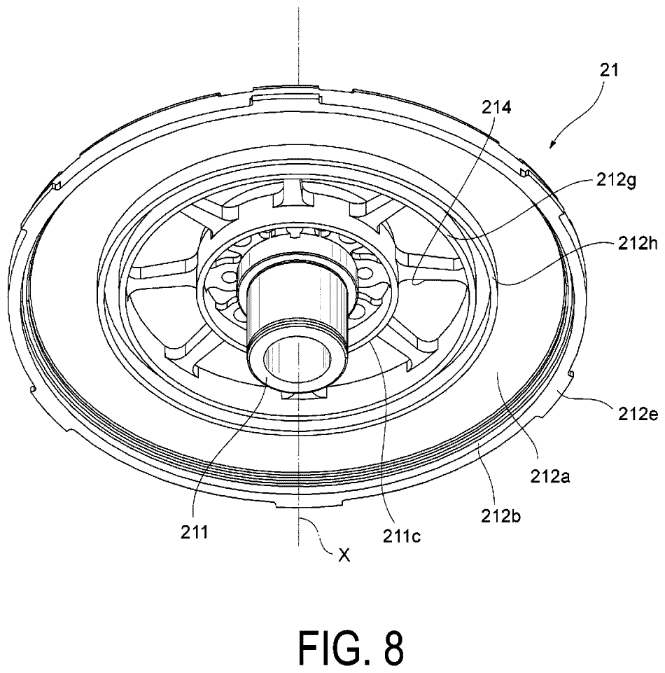

FIG. 7 is a partial cross-sectional view taken along line 7-7 in FIG. 1. FIG. 8 is a perspective view of the housing 21 alone, the perspective view schematically illustrating a configuration of the housing 21. Referring also to FIGS. 2, 7, and 8, the inner peripheral part 211 of the housing 21 includes, at a lower surface of the inner peripheral part 211 facing the interior space of the motor 1, an annular projecting part (hereinafter referred to as an “inner peripheral side projecting part”) 211c projecting downward in the axial line X direction toward the holder 11 along inner peripheral ends of the opening parts 214. On the other hand, the outer peripheral part 212 includes, at a lower surface of the outer peripheral part 212, a pair of annular projecting parts (hereinafter referred to as “outer peripheral side projecting parts”) 212g and 212h projecting downward in the axial line X direction toward the holder 11 along outer peripheral ends of the opening parts 214.

A lower end of the inner peripheral side projecting part 211c is disposed below the upper end of the inner wall part 111 of the holder 11. An inner peripheral surface of the inner peripheral side projecting part 211c opposes at least the outer peripheral surface of the inner wall part 111 of the holder 11 via a gap. As a result, as is clear from FIGS. 2 and 7, the inner peripheral side projecting part 211c covers, from the outer peripheral side, a gap formed between an upper surface of the inner wall part 111 of the holder 11 and the lower surface of the inner peripheral part 211 of the housing 21. In addition, the holder 11 includes, at the inside of the inner wall part 111 of the holder 11, a flange part 111b projecting toward the inner peripheral side. Note that the flange part 111b is in contact with the outer rings of the bearings 30. The lower end of the inner peripheral side projecting part 211c is disposed below an upper end of the flange part 111b. As a result, water and dust can be prevented from entering the bearings 30, and thus dustproof and waterproof performance is increased.

On the other hand, lower ends of the outer peripheral side projecting parts 212g and 212h are disposed below an upper end of the outer wall part 113 of the holder 11. Further, an outer peripheral surface of the outer peripheral side projecting part 211g at the inner peripheral side opposes the inner peripheral surface of the outer wall part 113 via a gap, while an inner peripheral surface of the outer peripheral side projecting part 211h at the outer peripheral side opposes the outer peripheral surface of the outer wall part 113 via a gap. As a result, as is clear from FIGS. 2 and 7, the two outer peripheral side projecting parts 212g and 212h cover, from the inner peripheral side and the outer peripheral side, a gap formed between the upper surface of the outer wall part 113 and the lower surface of the outer peripheral part 212 of the housing 21.

As is clear from FIG. 7, an outer peripheral surface of the axial direction projecting part 115c of the annular part 115 of the holder 11 opposes an inner peripheral surface of a lower end of the yoke 22 via a gap in the radial direction. Furthermore, an upper surface of the radial direction projecting part 115d extending from the lower end of the axial direction projecting part 115c toward the outer peripheral side opposes a lower surface of the yoke 22 via a gap in the axial line X direction. In the present embodiment, the outer diameter of the yoke 22 may coincide with the outer diameter of the radial direction projecting part 115d. However, the outer diameter of the radial direction projecting part 115d may be larger than the outer diameter of the yoke 22.

An accommodation space for the stator core 14, the coils 15, and the magnet 23 is formed by the outer wall part 113 and the annular part 115 of the holder 11 of the stator 10, the yoke 22, and the outer peripheral part 212 of the housing 21 of the rotor 20. Moreover, in the motor 1 according to the present embodiment, the gaps formed between the stator 10 and the rotor 20 (for example, the gap between the upper end of the inner wall part 111 and the lower surface of the inner peripheral part 211, the gap between the upper end of the outer wall part 113 and the inner surface of the outer peripheral part 212, and the gap between the outer peripheral end of the annular part 115 and the lower end of the yoke 22) opposes the inner peripheral side projecting part 211c, the outer peripheral side projecting parts 212g and 212h, the axial direction projecting part 115c, and the radial direction projecting part 115d.

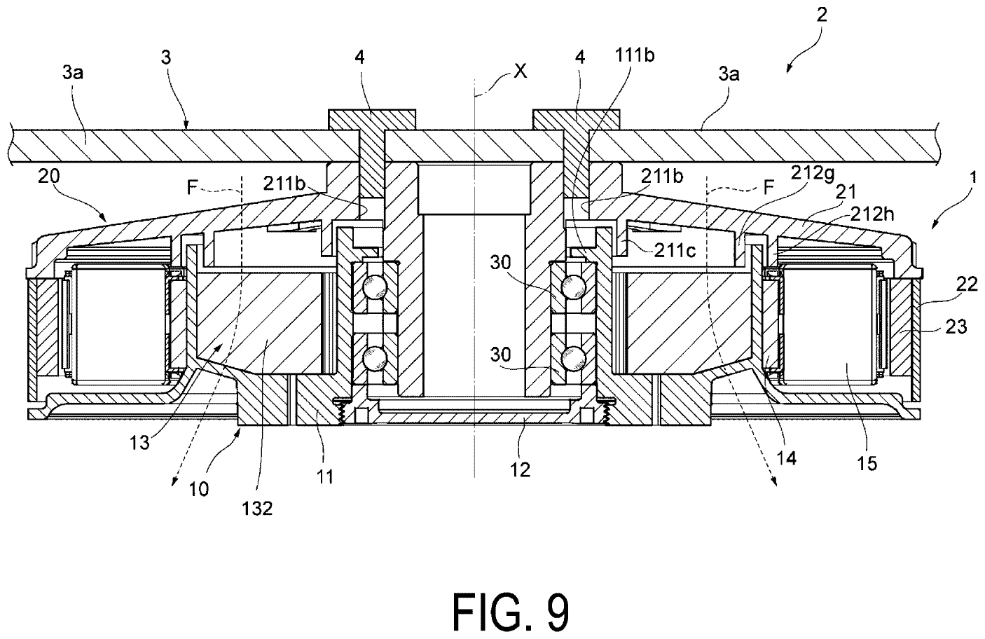

FIG. 9 is a cross-sectional view schematically illustrating a structure of a rotary blade device 2 according to the embodiment of the present invention. As illustrated in FIG. 9, the rotary blade device 2 includes the above-described motor 1 and a propeller 3 attached to the motor 1 rotatably about the axial line X. The propeller 3 is configured of, for example, a pair of blades 3a and 3a extending oppositely to each other in directions orthogonal to the axial line X. For example, screws 4 are screwed into the screw holes 211b of the housing 21 of the rotor 20 and thus the propeller 3 is attached to the motor 1. On the other hand, the rotary blade device 2 is attached to, for example, an aircraft body part of a UAV (external device) (not illustrated) with screws (not illustrated) screwed into the screw holes 112b of the holder 11 of the stator 10.

In a case where a current flows through the coils 15 of the stator 10, for example, when the UAV floats, the rotor 20 rotates around the axial line X with respect to the stator 10 due to interaction with a magnetic field generated by the magnet 23. Thus, the propeller 3 attached to the rotor 20 rotates around the axial line X. At this time, the coils 15 generate heat. The heat of the coils 15 is transferred to the main body 131 and the respective fins 132 of the heat sink 13 via the stator core 14 and the holder 11. Subsequently, the heat is released into the air from the main body 131 and the respective fins 132.

On the other hand, a flow of air F generated by rotation of the propeller 3 is directed from the propeller 3 toward the motor 1 along the axial line X. The flow of air F flows into the motor 1 through the opening parts 214 formed in the housing 21 of the rotor 20. Subsequently, the flow of air F flows between the plurality of fins 132 of the heat sink 13 and receives the heat released from the heat sink 13. The flow of heated air F is discharged from the opening parts 112a and the opening parts 114a of the holder 11 to the exterior space of the motor 1. Thus, since the flow of air F is forcibly generated in the motor 1 by the rotation of the propeller 3, the heat generation of the motor 1 can be efficiently suppressed.

According to the motor 1 described above, as illustrated in FIG. 7, the upper end of the outer wall part 113 of the holder 11 opposes the outer peripheral side projecting parts 212g and 212h via the gaps in the radial direction. That is, since the gap, between the outer wall part 113 of the holder 11 and the outer peripheral part 212 of the housing 21, in communication with the accommodation space for the stator core 14 and the coils 15 opposes the outer peripheral side projecting parts 212g and 212h in the radial direction, a flow path of air formed between the outer wall part 113 and the outer peripheral part 212 is bent. As a result, for example, water and dust having flowed into the motor 1 from the opening parts 214 due to the flow of air F can be prevented from entering the accommodation space for the stator core 14 and the coils 15, and thus dustproof and waterproof performance is increased. Note that since the outer wall part 113 and the outer peripheral side projecting parts 212g and 212h oppose each other via the gaps, an air inflow port is formed between the outer wall part 113 and the outer peripheral side projecting parts 212g and 212h. Thus, the heat generation of the motor 1 can be efficiently suppressed.

In addition, the upper end of the inner wall part 111 of the holder 11 opposes the inner peripheral side projecting part 211c via the gap in the radial direction. That is, since the gap, between the inner wall part 111 of the holder 11 and the inner peripheral part 211 of the housing 21, in communication with the accommodation space for the bearings 30 and 30 opposes the inner peripheral side projecting part 211c in the radial direction, a flow path of air formed between the inner wall part 111 and the inner peripheral part 211 is bent. As a result, for example, water and dust having flowed into the motor 1 from the opening parts 214 due to the flow F of air can be prevented from entering the accommodation space for the bearings 30 and 30, and thus dustproof and waterproof performance is increased.

Furthermore, since the lower end of the yoke 22 opposes the axial direction projecting part 115c of the annular part 115 of the holder 11 via the gap in the radial direction and opposes the radial direction projecting part 115d of the annular part 115 via the gap in the axial line X direction, a flow path of air formed between the yoke 22 and the annular part 115 is bent. As a result, for example, water and dust from the exterior space of the motor 1 can be prevented from entering the accommodation space for the stator core 14 and the coils 15, and thus dustproof and waterproof performance is increased.

Moreover, according to the motor 1 of the present embodiment, the accommodation space for the stator core 14 and the coils 15 is covered by the outer wall part 113 and the annular part 115 of the holder 11, the outer peripheral part 212 of the housing 21, and the yoke 22. On the other hand, the heat sink 13 opposing the stator core 14 via the outer wall part 113 in the radial direction is disposed in the flow path of air in communication from the opening parts 214 to the opening parts 112a and the opening parts 114a. As a result, the heat generation of the motor 1 can be efficiently suppressed while dustproof and waterproof performance is increased.

As described above, the motor 1 has been described with reference to the preferred embodiment, but the motor 1 is not limited to the above-described embodiment. For example, the present invention can also be applied to a motor other than a brushless motor, and a motor of an inner-rotor type. Further, for example, in the housing 21, one of the pair of outer peripheral side projecting parts 212h and 212g disposed at the outer peripheral side may be omitted. That is, only the outer peripheral side projecting part 212g or only the outer peripheral side projecting part 212h may be formed.

On the other hand, in the holder 11, the radial direction projecting part 115d may be omitted. That is, only the axial direction projecting part 115c may be formed. In addition, the holder 11 may include an axial direction projecting part (not illustrated) projecting upward in the axial line X direction from an outer peripheral end of the radial direction projecting part 115d and, for example, opposing the outer peripheral surface of the main body 221 of the yoke 22 via a gap.

The present invention is not limited to the motor 1 and the rotary blade device 2 according to the embodiment described above, and includes various aspects included in concepts and claims of the present invention. Further, the configurations may be selectively combined as appropriate so as to achieve at least part of the objects and the effects described above. For example, each of the configurations in the embodiment described above may be changed as appropriate according to a specific usage aspect of the present invention.

### REFERENCE SIGNS LIST

1 Motor, 2 Rotary blade device, 3 Propeller, 3a Blade, 4 Screw, 10 Stator, 11 Holder, 12 Pusher, 12a Male screw, 13 Heat sink, 14 Stator core, 15 Coil, 16 Insulator, 20 Rotor, 21 Housing, 22 Yoke, 23 Magnet, 30 Bearing, 111 Inner wall part, 111a Female screw, 111b Flange part, 112 Attachment part, 112a Opening part (second opening part), 112b Screw hole, 113 Outer wall part (second projecting part), 114 Connection part, 114a Opening part (second opening part), 115 Annular part, 115a Inclined part, 115b Flat part, 115c Axial direction projecting part (third projecting part), 115d Radial direction projecting part (fourth projecting part), 131 Main body, 132 Fin, 141 Base end part, 142 Tooth, 143 Distal end part, 211 Inner peripheral part, 211a Through hole, 211b Screw hole, 211c Inner peripheral side projecting part, 212 Outer peripheral part, 212a Covering part 212a, 212b Projecting part 212b, 212c Recessed part, 212d Bottom surface, 212e Protruding part, 212f Bottom surface, 212g Outer peripheral side projecting part (first projecting part), 212h Outer peripheral side projecting part (first projecting part), 213 Spoke, 214 Opening part (first opening part), 221 Main body, 222 Cutout, 222a Side surface, 222b Bottom surface, 222c Engaging part, X axial line

1. A motor comprising:
an annular rotor; and
a stator opposing the rotor, wherein
the rotor includes a magnet and a housing covering the magnet,
the stator includes a coil and a holder holding the coil,
the housing includes a first projecting part projecting toward the holder,
the holder includes a second projecting part projecting toward the housing, and
the second projecting part opposes the first projecting part via a gap in a radial direction.

2. The motor according to claim 1, wherein
the rotor includes a yoke in contact with the magnet,
the holder includes a third projecting part projecting in an axial direction, and
the third projecting part opposes the yoke via a gap in the radial direction.

3. The motor according to claim 2, wherein
the holder includes a fourth projecting part projecting from the third projecting part in the radial direction, and
the fourth projecting part opposes the yoke via a gap in the axial direction.

4. The motor according to claim 1, wherein
the housing includes a first opening part opening in the axial direction,
the holder includes a second opening part opening in the axial direction, and
the first opening part and the second opening part are in communication with each other.

5. The motor according to claim 4, wherein
the stator includes a heat radiating part in contact with the holder, and
the heat radiating part is disposed between the first opening part and the second opening part.

6. A rotary blade device comprising:
the motor according to claim 1; and
a propeller attached to the motor rotatably about an axial line.
